(19) United States
(12) Patent Application Publication
(10) Pub. No.: US 2026/0241435 A1
(43) Pub. Date: Aug. 20, 2026

(54) FORMING SYSTEM

(71) Applicant: SUMITOMO HEAVY INDUSTRIES, LTD., Tokyo (JP)

(72) Inventors: Noboru ITAGAKI, Niihama-shi (JP); Norieda UENO, Niihama-shi (JP); Daigo HOTTA, Chiba-shi (JP); Koki INOUE, Chiba-shi (JP)

(21) Appl. No.: 19/642,673

(22) Filed: Apr. 9, 2026

Related U.S. Application Data
(63) Continuation of application No. PCT/JP2024/043116, filed on Dec. 5, 2024.

(30) Foreign Application Priority Data
Dec. 5, 2023 (JP) 2023-205126

(51) Int. Cl. B21D 26/025; B21D 26/027; B21D 37/16

(52) U.S. Cl. CPC B21D 26/025; B21D 26/027; B21D 37/16

(57) ABSTRACT

A forming system includes a forming device configured to form a metal pipe material in a non-molten state, in which the forming device includes at least a pair of molds that move relative to each other in a moving direction along a horizontal direction, and the forming device is configured to perform the forming by disposing the metal pipe material from a direction intersecting the moving direction with respect to the pair of molds, and supply a gas to an inside of the metal pipe material to form an expanded metal pipe material.

### CROSS-REFERENCE TO RELATED APPLICATIONS

This is a bypass continuation of International PCT Application No. PCT/JP2024/043116, filed on December 5, 2024, which claims priority to Japanese Patent Application No. 2023-205126, filed on December 5, 2023, which are incorporated by reference herein in their entirety.

### BACKGROUND

### Technical Field

A certain embodiment of the present invention relates to a forming system.

### Description of Related Art

In the related art, as a device that processes a heated metal material, a device described in the related art is known. This processing device is a forming device. The forming device can perform quenching at the same time as forming by bringing a heated metal pipe material into contact with a forming mold.

### SUMMARY

One or more embodiments provide a forming system including a forming device configured to form a metal pipe material in a non-molten state, in which the forming device includes at least a pair of molds that move relative to each other in a moving direction along a horizontal direction, and the forming device is configured to perform the forming by disposing the metal pipe material from a direction intersecting the moving direction with respect to the pair of molds, and supply a gas to an inside of the metal pipe material to form an expanded metal pipe material.

### BRIEF DESCRIPTION OF THE DRAWINGS

FIG. 1 is a schematic plan view showing a configuration of a forming system, according to the present embodiment.

FIG. 2 is a schematic front view showing the configuration of the forming system, according to the present embodiment.

FIG. 3 is a schematic front view showing the configuration of the forming system, according to the present embodiment.

FIG. 4 is a schematic side view showing the configuration of the forming system, according to the present embodiment.

FIG. 5 is a schematic side view showing the configuration of the forming system, according to the present embodiment.

FIGS. 6A and 6B are enlarged views of molds.

FIGS. 7A and 7B are enlarged views of the molds.

FIGS. 8A and 8B are views explaining an operation of a support mechanism.

FIG. 9 is a schematic side view showing a configuration of a forming system, according to a modification example.

FIG. 10 is a schematic side view showing the configuration of the forming system, according to the modification example.

FIGS. 11A and 11B are schematic views explaining a lock-up mechanism.

FIGS. 12A and 12B are schematic views explaining the lock-up mechanism.

FIGS. 13A and 13B are views showing a forming mold, according to the modification example.

FIG. 14 is a view showing the forming mold, according to the modification example.

FIG. 15 is a view showing the forming mold, according to the modification example.

### DETAILED DESCRIPTION

Here, in the forming system in the related art, a hydraulic press for moving a mold in an up-down direction by hydraulic pressure or the like is performed. Such a hydraulic press requires large-scale foundation work, such as an underground pit. In addition, there is an issue in that a hydraulic unit and pipes are required, hydraulic pressure adjustment or the like is required during a trial operation, and a period of time until start-up is long. That is, there is an issue in that in the hydraulic press, an initial cost at the time of introduction is high.

According to the present disclosure, it is possible to provide a forming system that can be easily introduced.

The forming device may include at least a pair of molds that move relative to each other in a moving direction along a horizontal direction. Therefore, unlike a case where the pair of molds move in the up-down direction, the forming can be performed in a state where both the pair of molds are supported by their weights on a floor surface. That is, a brake mechanism or the like for supporting the weight of the pair of molds is not required. Therefore, in the forming device, a large force can be generated as in hydraulic pressure, but a mechanism that requires a cost for introduction is not required. As described above, the forming system can be easily introduced.

The forming device may perform the forming by disposing the metal material from the direction intersecting the moving direction with respect to the pair of molds, the direction being a horizontal direction. In this case, the forming device can be lowered as compared with a case where the metal material is disposed with respect to the pair of molds from a vertical direction. Therefore, it is possible to reduce a restriction in a height direction in a building in a case of introducing the forming system.

The forming device may further include a driver configured to move the mold, and a fluid supplier configured to supply a fluid to the metal material, the pair of molds may include pipe forming surfaces for forming a flanged metal pipe and flange forming surfaces, and the driver may stop the mold at a mold closing position that is a position of the pair of molds when the metal pipe is completed, and a primary blow position where the flange is formed by supplying the fluid in a state where the flange forming surfaces are spaced apart from each other as compared with the mold closing position. In this case, a part of the metal material can be inserted between flange forming surfaces at a primary blow position that is a stage before completely reaching the mold closing position. As a result, it is possible to suppress cracking or the like as compared with a case where the flange is formed at once.

The forming device may further include a support mechanism configured to support the transported metal material at a position between the pair of molds and align a position of the metal material. In this case, the metal material can be disposed at an accurate position by the support mechanism.

The forming system may further include a first transporter configured to dispose the metal material with respect to the pair of molds; and a second transporter configured to take out a formed product from the pair of molds, in which the first transporter and the second transporter may be disposed to sandwich the forming device. In this case, the metal material before the forming and the formed product can be quickly exchanged.

The forming device may further include a pair of fluid suppliers configured to supply a fluid to the metal material, and the pair of fluid suppliers may be disposed to sandwich the molds. In this case, the fluid can be supplied to the metal material disposed between the pair of molds from both sides.

The forming device may further include a driver configured to move the molds and the driver may include a toggle link mechanism. In this case, the mold can be moved with a large force even with a small driving force with respect to the mold disposed such that the moving direction is along the horizontal direction.

The toggle link mechanism may be provided with a rattling suppression mechanism configured to suppress rattling occurring in a gap that is provided in a gear for mold thickness adjustment and in a gap in a sliding portion of a link of the toggle link mechanism. In the toggle link mechanism, the gap generated in a gear for mold thickness adjustment and in a gap in a sliding portion of a link of the toggle link mechanism are present. Rattling is likely to occur in such gaps. Therefore, the rattling suppression mechanism can suppress the rattling, and thus the position controllability of the mold can be improved.

The rattling suppression mechanism may include a load applying mechanism configured to apply a load to a toggle link mechanism side. The load applying mechanism can suppress generation of the gap that causes the rattling by applying the load to the toggle link mechanism side. As a result, the position controllability of the mold can be improved by suppressing the rattling.

The toggle link mechanism may include a position detection mechanism configured to detect a position of a movable mold. In this case, even in a case where rattling occurs in the gap generated in the gear for mold thickness adjustment and the gap in the sliding portion of the link of the toggle link mechanism, the position detection mechanism detects the position of the movable mold, and thus the position of the movable mold is feedback-controlled, and thus the position controllability of the mold can be improved.

The driver may include a motor, and the motor may be provided in the moving direction. In this case, a power transmission mechanism such as a V-belt or a timing belt is not required separately, and thus a driver that is less likely to break can be provided. In addition, the size of the forming system in a height direction can be limited.

The driver may include a motor, and the motor may be provided in a direction intersecting the moving direction. In this case, the size of the forming system in the moving direction can be suppressed. In addition, in a case where the motor is disposed on an upper side of the forming system, maintenance can be performed from the upper side, and thus maintainability can be improved.

The toggle link mechanism may include a lock-up mechanism configured to retain a mold clamping force. In this case, since the lock-up mechanism can retain the mold clamping force, mold opening can be suppressed even in a case where a reaction force is received from the metal material disposed in the mold.

The lock-up mechanism may be operated at the time of stopping. In this case, the lock-up mechanism can suppress the mold opening at the time of stopping.

The forming device may further include a double-action mold, and the double-action mold may be disposed on any one side of the metal material in a direction intersecting the horizontal direction. In this case, the metal material can be formed into a complicated shape by the double-action mold. Here, in a case where the pair of molds move in the up-down direction, there is an issue in that suction work or the like is required because an oxide scale is likely to be deposited on a lower mold. On the other hand, in the pair of molds that relatively move in the horizontal direction, the oxide scale is likely to fall downward, and thus the oxide scale can be easily removed by blowing the oxide scale with a blow or the like. In a case where the double-action mold is adopted, an adverse effect due to the deposition of the oxide scale is more remarkable, but the adverse effect can be suppressed by adopting a configuration in which the oxide scale is easily removed.

The double-action mold may include a moving mechanism configured to move from a lower side to an upper side in conjunction with mold closing during forming, and the double-action mold may return to an original position by its own weight during mold opening. In this case, a mechanism for returning the double-action mold to the original position can be reduced in size or omitted.

Hereinafter, a preferred embodiment of the present disclosure will be described with reference to the accompanying drawings. In each drawing, identical or corresponding portions are denoted by the same reference numerals, and redundant description will be omitted.

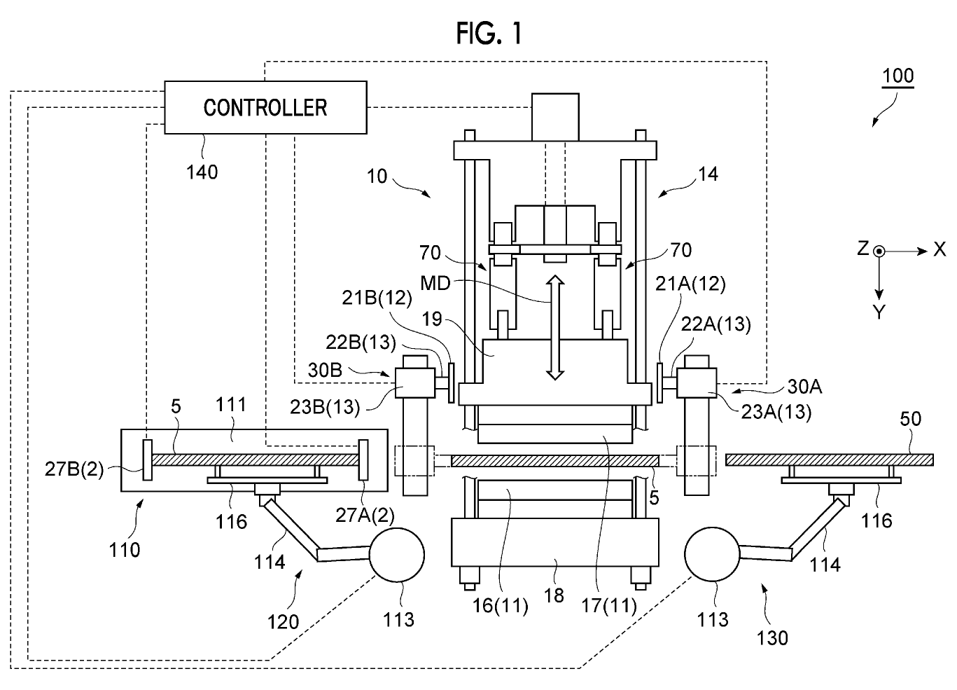

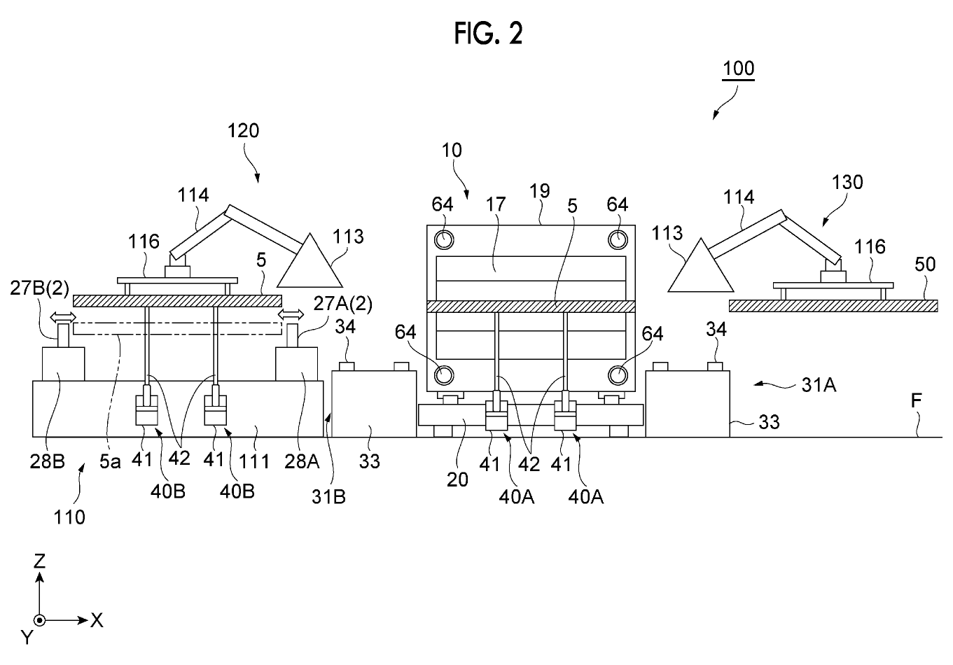

FIGS. 1 and 2 are schematic configuration diagrams showing a configuration of a forming system 100 according to the present embodiment. FIG. 1 is a plan view of the forming system 100. FIG. 2 is a front view of the forming system 100. The forming system 100 is a system that forms a metal material in a non-molten state. Note that in FIG. 2, a structure around a mold 16 on a positive side in a Y-axis direction is omitted for understanding of a structure. In the present embodiment, a heated metal pipe material 5 is used as the metal material in a non-molten state. As shown in FIGS. 1 and 2, the forming system 100 includes a forming device 10, a material disposition unit 110, a transporter 120, a transporter 130, and a controller 140.

The forming device 10 is a device that forms the metal pipe material 5. The forming device 10 is a device that forms the heated metal pipe material 5 with a forming mold 11 (die). In the present embodiment, as the forming device 10, a forming device that forms and quenches a hollow flanged metal pipe 50 by supplying a fluid to the heated metal pipe material 5 and bringing the fluid into contact with a forming surface of the forming mold 11 is adopted.

The forming device 10 is installed on a horizontal plane F (refer to FIG. 2). The forming device 10 includes the forming mold 11, a holder 12, a fluid supplier 13, and a driver 14. Note that in the present specification, the metal pipe material 5 refers to a hollow article of which forming to be performed by the forming device 10 is not yet completed. The metal pipe material 5 is a pipe material made of a type of steel that can be quenched. In the following description, the description will be made with an XYZ coordinates set. A Z-axis direction is an up-down direction. An upper side is a positive side in the Z-axis direction, and a lower side is a negative side. An X-axis direction is any direction in a horizontal direction. A Y-axis direction is a horizontal direction orthogonal to the Z-axis direction and the X-axis direction. In the present specification, a longitudinal direction of the metal pipe material 5 when the metal pipe material 5 is formed by the forming device 10 is defined as the X-axis direction. One side in the X-axis direction is a positive side, and the other side is a negative side. One side in the Y-axis direction is a positive side, and the other side is a negative side.

The forming mold 11 is a mold that forms the metal pipe 50 from the metal pipe material 5, and includes a pair of molds 16 (dies) and molds 17 (dies) that face each other in the Y-axis direction, which is a horizontal direction. The mold 16 and the mold 17 reciprocate relative to each other in the Y-axis direction, which is a horizontal direction, as a moving direction MD. The moving direction MD may be any direction along the horizontal direction. In the present embodiment, the moving direction MD is horizontal to the horizontal direction, but may not be horizontal, and the moving direction MD may be inclined with respect to the horizontal direction. Even in such a case, weights of the molds 16 and 17 are supported by a floor surface. At least one of the mold 16 and the mold 17 may move, but in the present embodiment, a position of the mold 16 is fixed, and the mold 17 reciprocates in the Y-axis direction. Each of the mold 16 and the mold 17 is formed of a steel block. Each of the mold 16 and the mold 17 is provided with a recessed portion that accommodates the metal pipe material 5 (details will be described later). The mold 16 is fixed to a stationary platen 18. The mold 17 is fixed to a movable platen 19. Further, the mold 17 is fixed to the driver 14 via the movable platen 19, or the like. Note that the driver 14 is a mechanism that moves at least one of the mold 16 and the mold 17, and in the present embodiment, the driver 14 moves the mold 17. A cooling mechanism that cools each of the molds 16 and 17 is provided inside each of the molds 16 and 17.

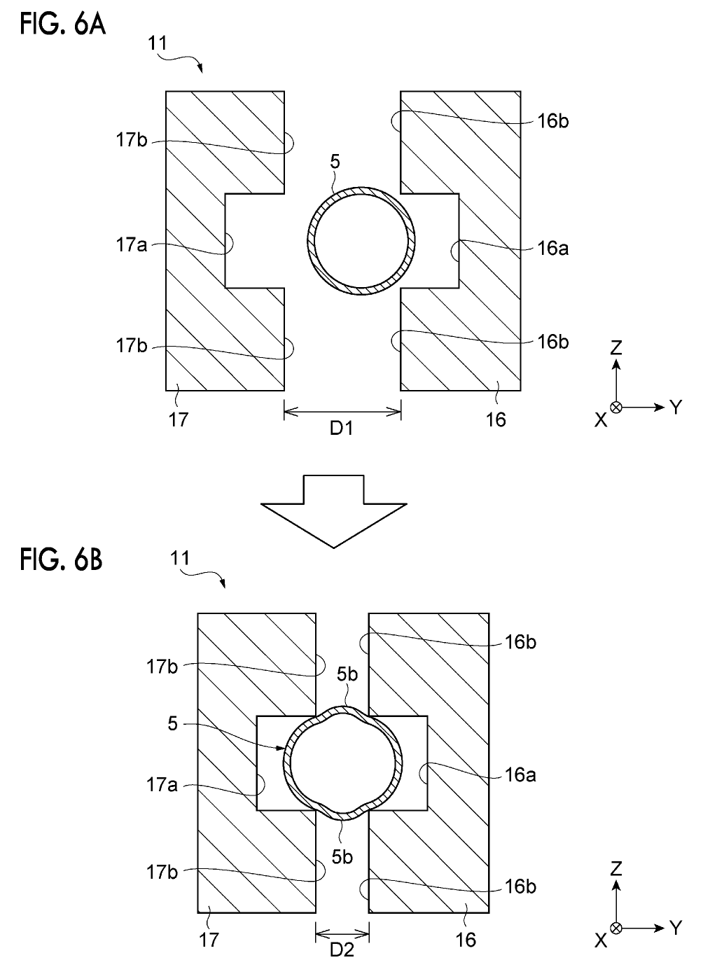

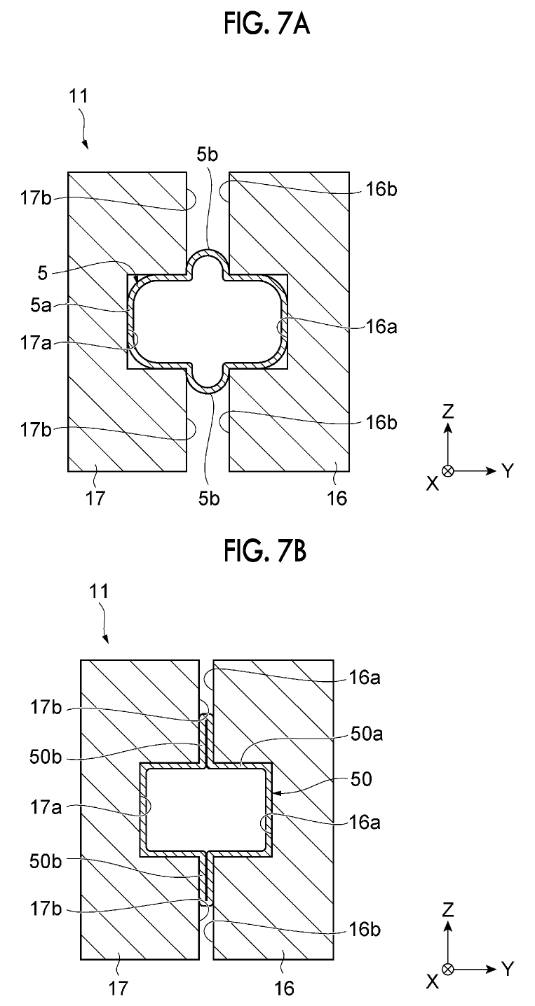

Here, forming surfaces of the molds 16 and 17 will be described with reference to FIGS. 6A, 6B, 7A, and 7B. As shown in FIG. 7B, the metal pipe 50, which is a formed product, has a tubular pipe main body 50a and a pair of flanges 50b. On the other hand, the molds 16 and 17 have pipe forming surfaces 16a and 17a for forming the pipe main body 50a and flange forming surfaces 16b and 17b for forming the flanges 50b. The pipe forming surfaces 16a and 17a are formed in a cavity that is recessed with respect to the flange forming surfaces 16b and 17b. The heated metal pipe material 5 expands in the forming mold 11 to come into contact with the pipe forming surfaces 16a and 17a, thereby forming the pipe main body 50a. In addition, a part of the metal pipe material 5 is crushed against the flange forming surfaces 16b and 17b to form the flanges 50b.

As shown in FIG. 2, the forming device 10 further includes a support mechanism 40A that supports the metal pipe material 5 transported to a position between the pair of molds 16 and 17 and aligns the position of the metal pipe material 5. The support mechanism 40A is disposed on a lower side of the metal pipe material 5 during the forming. The support mechanism 40A includes a high-speed lift 41 and a support member 42. The high-speed lift 41 is configured by, for example, a cylinder including a piston rod. The high-speed lift 41 advances and retreats the support member 42 in the up-down direction. The support member 42 is supported by the high-speed lift 41 on a lower end side and extends upward. The support member 42 supports the metal pipe material 5 at an upper end. The upper end of the support member 42 has a shape corresponding to the metal pipe material 5 to support the disposed metal pipe material 5. Alternatively, a mechanism that clamps the metal pipe material 5 may be provided at the upper end of the support member 42. A plurality of the support mechanisms 40A are provided along the X-axis direction in which the metal pipe material 5 extends. The number of the support mechanisms 40A is not particularly limited. Details of an operation of the support mechanisms 40A will be described later.

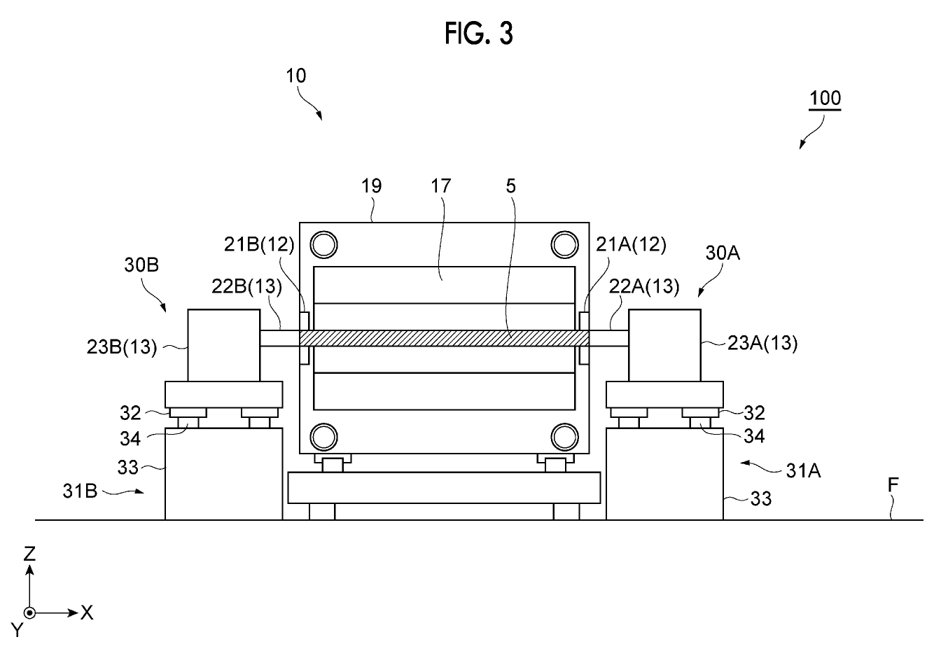

As shown in FIGS. 1 and 3, the holder 12 is a mechanism that holds the metal pipe material 5 disposed between the mold 16 and the mold 17. The holder 12 includes a holding member 21A that holds the metal pipe material 5 on the positive side of the forming mold 11 in the X-axis direction during the forming, and a holding member 21B that holds the metal pipe material 5 on the negative side of the forming mold 11 in the X-axis direction. The holding members 21A and 21B may be divided into, for example, an upper member and a lower member, respectively, and may hold the metal pipe material 5 by sandwiching the vicinity of an end of the metal pipe material 5 from the up-down direction. Each of the holding members 21A and 21B is provided with a drive mechanism (not shown), and is movable in the up-down direction. The holding member does not need to be divided into an upper side and a lower side, and may be divided into, for example, a left side and a right side.

The fluid supplier 13 is a mechanism that supplies a high-pressure fluid into the metal pipe material 5 held between the mold 16 and the mold 17. The fluid supplier 13 supplies the high-pressure fluid to the metal pipe material 5 in a high-temperature state to expand the metal pipe material 5. The fluid supplier 13 is provided on both end sides of the forming mold 11 in the X-axis direction. The fluid supplier 13 includes nozzles 22A and 22B, each of which supplies the fluid from an opening of the end of the metal pipe material 5 to the inside of the metal pipe material 5, and drive mechanisms 23A and 23B that advance and retreat the nozzles 22A and 22B with respect to the opening of the metal pipe material 5. The fluid supplier 13 may supply gas, such as high-pressure air or inert gas, as the fluid.

Note that the holding members 21A and 21B of the holder 12 and the nozzles 22A and 22B and the drive mechanisms 23A and 23B of the fluid supplier 13 may be incorporated as the same unit in combination with a mechanism that moves the metal pipe material 5 in the up-down direction. Such units may be referred to as units 30A and 30B. The pair of units 30A and 30B including the fluid supplier 13 are disposed to sandwich the forming mold 11 in the X-axis direction.

The units 30A and 30B are reciprocally movable in the Y-axis direction along guide mechanisms 31A and 31B provided to extend in the Y-axis direction. As shown in FIG. 3, sliders 32 are provided on lower surfaces of the units 30A and 30B. The guide mechanisms 31A and 31B include a base 33 and a guide member 34 provided on the base 33. The guide member 34 extends in the Y-axis direction. The units 30A and 30B move in the Y-axis direction along the guide member 34 via the sliders 32.

The driver 14 is a mechanism that moves the mold 17. The driver 14 is provided on a negative side in the Y-axis direction with respect to the forming mold 11. The driver 14 reciprocally moves the mold 17 via the movable platen 19 with the Y-axis direction, which is the horizontal direction, as the moving direction MD. Note that the forming mold 11, the platens 18 and 19, and the driver 14 are disposed on a base stage 20 installed on the horizontal plane F. On the base stage 20, the platens 18 and 19 supporting the molds 16 and 17 are disposed to rise upward from the base stage 20. Therefore, the base stage 20 and the horizontal plane F support the weight of the molds 16 and 17 from below via the platens 18 and 19. A further detailed configuration of the driver 14 will be described later.

The material disposition unit 110 is a place where the metal pipe material 5 immediately before being formed by the forming device 10 is disposed. The position of the material disposition unit 110 is not particularly limited, but in the present embodiment, the material disposition unit 110 is disposed on the negative side in the X-axis direction of the forming device 10. The material disposition unit 110 includes a base 111 and a support mechanism 40B. The base 111 is a table installed on the horizontal plane F. The support mechanism 40B is a mechanism that supports the metal pipe material 5 on the base 111 and moves the metal pipe material 5 in the up-down direction. The support mechanism 40B has a configuration similar to that of the support mechanism 40A of the forming device 10 described above, and includes a high-speed lift 41 and a support member 42. The support mechanism 40B receives and supports the metal pipe material 5, and moves the metal pipe material 5 to a position where the metal pipe material 5 is easily received by the transporter 120.

Here, in the present embodiment, energization heaters 2 are provided on the base 111. The energization heaters 2 are devices that energize and heat the metal pipe material 5. The energization heaters 2 energize the metal pipe material 5 to heat the metal pipe material 5. The energization heaters 2 are disposed adjacent to each other at positions spaced apart from the forming device 10 in the X-axis direction. The energization heaters 2 are provided on the base 111. The energization heaters 2 include electrodes 27A and 27B disposed to be spaced apart from each other in the X-axis direction. Each of the electrodes 27A and 27B is divided into an upper member and a lower member, and holds the metal pipe material 5 by pinching the vicinity of the end of the metal pipe material 5 in the up-down direction. The electrodes 27A and 27B are supported by pedestal portions 28A and 28B provided on the base 111. The energization heaters 2 cause a current to flow from a power supply (not shown) to the metal pipe material 5 via the electrodes 27A and 27B in a state where the metal pipe material 5 is held by the electrodes 27A and 27B. The electrodes 27A and 27B are provided with a drive mechanism (not shown), and the divided members are movable in the up-down direction. Each of the electrodes 27A and 27B does not need to be divided into upper and lower portions, and may be divided into left and right portions. Instead of being provided in the material disposition unit 110, the holder 12 of the units 30A and 30B may also function as the energization heaters 2. In this case, the holding members 21A and 21B are configured as electrodes.

The transporter 120 (first transporter) is a mechanism that disposes the metal pipe material 5 with respect to the pair of molds 16 and 17. The transporter 120 holds the metal pipe material 5 disposed in the material disposition unit 110 and transports the metal pipe material 5 to the forming device 10. After the transporter 120 transports the metal pipe material 5 to the forming device 10, the metal pipe material 5 is disposed with respect to the forming mold 11. The transporter 130 (second transporter) is a mechanism that takes out the metal pipe 50, which is the formed product, from the pair of molds 16 and 17. The transporter 130 holds the metal pipe 50 formed by the forming mold 11 and transports the metal pipe 50 to a place of another process. The transporter 120 is disposed on the negative side in the X-axis direction with respect to the forming device 10, and the transporter 130 is disposed on the positive side in the X-axis direction with respect to the forming device 10. With such a disposition, the transporter 120 and the transporter 130 are disposed to sandwich the forming device 10. The positions of the transporters 120 and 130 are not particularly limited, and may be positions at which interference with the units 30A and 30B or the like can be avoided.

The transporters 120 and 130 are configured by, for example, robot arms. The transporters 120 and 130 include a main body 113, an arm 114, and a holder 116. The main body 113 is provided on the horizontal plane F and supports the arm 114 to be able to turn. The arm 114 moves the holder 116 by a multi-joint mechanism. The holder 116 holds the metal pipe material 5 (metal pipe 50).

The controller 140 is a device that controls the entire forming system 100. The controller 140 is connected to the holder 12, the fluid supplier 13, the driver 14, the energization heater 2 (power supply), and the transporters 120 and 130, and transmits a command signal to these devices. Details of the control content by the controller 140 will be described later.

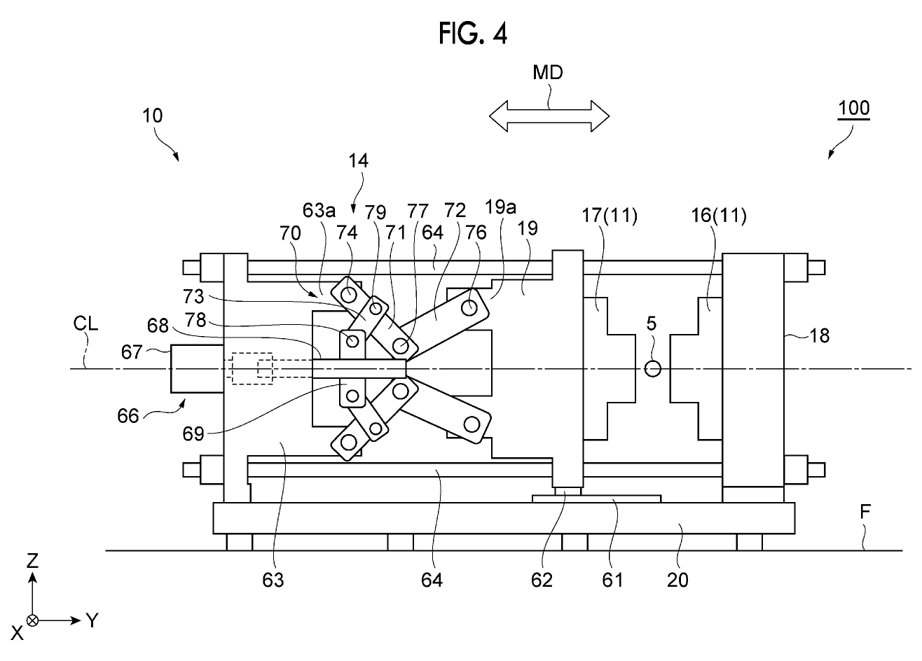

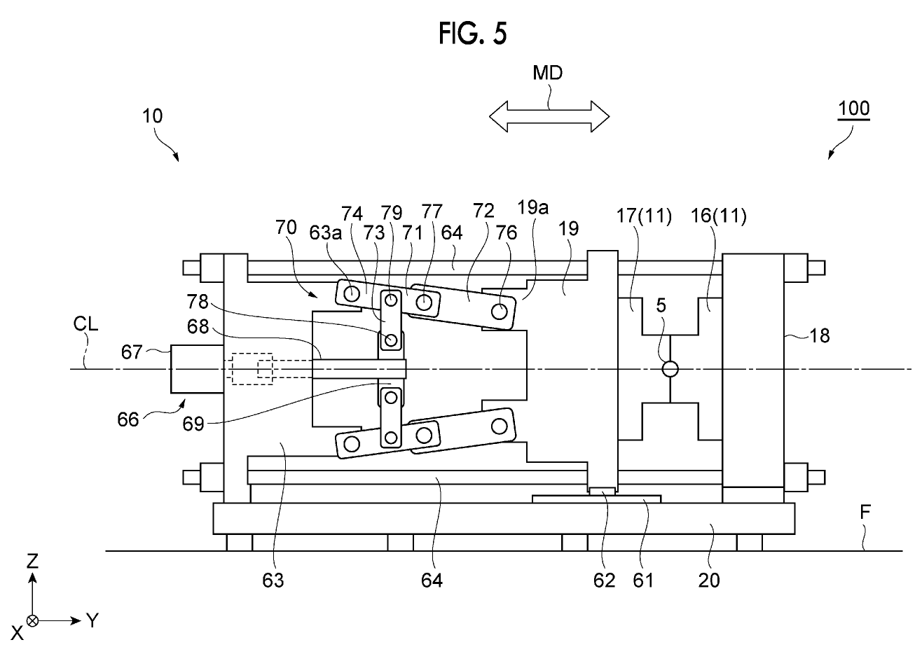

Next, a configuration of the driver 14 of the forming device 10 will be described in detail with reference to FIGS. 4 and 5. The driver 14 reciprocates the movable platen 19 that supports the mold 17 in the moving direction MD. The movable platen 19 includes a slider 62 that moves along a guide member 61 provided on the base stage 20 in order to enable the movement. A base member 63 is provided on the base stage 20 at an end of the forming device 10 on the negative side in the Y-axis direction. The base member 63 is supported on the base stage 20. Further, the base member 63 can move forward and backward in the Y-axis direction in FIG. 4. The base member 63 is provided to face the movable platen 19 in a state of being spaced apart from each other in the Y-axis direction. The base member 63, the movable platen 19, and the stationary platen 18 are connected to each other at four corners by tie bars 64 (also refer to FIG. 2). The movable platen 19 and the base member 63 move in the moving direction MD in a state of being guided by the tie bars 64.

The driver 14 includes a driving force applying portion 66 and a toggle link mechanism 70. The driving force applying portion 66 is a mechanism that applies a driving force to the movable platen 19 via the toggle link mechanism 70. The toggle link mechanism 70 is a link mechanism that transmits the driving force from the driving force applying portion 66 to the movable platen 19.

The driving force applying portion 66 is provided at an end of the base member 63 in the Y-axis direction. The driving force applying portion 66 includes a motor 67, a ball screw 68, and a moving member 69. The motor 67 is a power source that rotates the ball screw 68. The ball screw 68 is rotated by a driving force from the motor 67. The ball screw 68 extends from the motor 67 to the positive side in the Y-axis direction and passes through the base member 63. The moving member 69 is pivotally supported by the ball screw 68 at a position on the positive side of the base member 63 in the Y-axis direction. The moving member 69 is a member that reciprocates in the moving direction MD as the ball screw 68 rotates. The driving force applying portion 66 is not a mechanism that generates a large force such as hydraulic force, but is a mechanism that applies a driving force by an electric motor.

The toggle link mechanism 70 includes a plurality of link members 71, 72, and 73. Each of the link members 71, 72, and 73 is provided in a pair with a center line CL interposed therebetween. The center line CL is set at the center of the forming device 10 when viewed in the X-axis direction. The toggle link mechanism 70 has a configuration that is line-symmetrical with respect to the center line CL. Therefore, hereinafter, only one link mechanism with respect to the center line CL will be described. Further, a pair of the toggle link mechanisms 70 shown in FIGS. 4 and 5 are provided to be spaced apart from each other in the X-axis direction (refer to FIG. 1). A pair of support 63a for supporting the link member 71 of the toggle link mechanism 70 are provided at upper and lower ends of the base member 63 on the positive side in the Y-axis direction. A pair of supports 19a for supporting the link member 72 of the toggle link mechanism 70 are provided at upper and lower ends of the movable platen 19 on the negative side in the Y-axis direction.

One end of the link member 71 is rotatably connected to the support 63a of the base member 63 via a link 74. One end of the link member 72 is rotatably connected to the support 19a of the movable platen 19 via a link 76. The other end of the link member 71 and the other end of the link member 72 are rotatably connected to each other via a link 77. One end of the link member 73 is rotatably connected to the moving member 69 via a link 78. The other end of the link member 73 is rotatably connected to a middle position of the link member 71 via a link 79.

As shown in FIG. 4, in a mold opening state in which the mold 17 is spaced apart from the mold 16 to the negative side in the Y-axis direction, the link member 71 and the link member 72 have an L-shaped bent positional relationship in which the link 77 is close to the center line CL side. The link member 73 is inclined to be away from the center line CL as going toward the positive side in the Y-axis direction from the link 78 with the moving member 69. Next, as shown in FIG. 5, when the ball screw 68 is rotated by the driving force of the motor 67, the moving member 69 moves to the positive side in the Y-axis direction. In this case, when the link 78 is moved to the positive side in the Y-axis direction by the moving member 69, the link member 73 is pushed, and thus the link 79 is moved in a direction away from the center line CL together with the link member 71. As a result, the link member 71 is rotated around the link 74, and the link 77 is moved to the positive side in the Y-axis direction. As a result, the link member 72 is moved to the positive side in the Y-axis direction together with the movable platen 19. As described above, the mold 17 is moved to approach the mold 16, and the mold 17 comes into contact with the mold 16 to be in a mold closing state.

Next, an operation of the forming system 100 will be described. Note that an operation of each component is performed by the controller 140 by transmitting a control signal to each component. As shown in FIGS. 1 and 2, first, a new metal pipe material 5 is disposed in the material disposition unit 110. The electrodes 27A and 27B are moved inward to hold the metal pipe material 5. Next, the energization heater 2 energizes and heats the metal pipe material 5 via the electrodes 27A and 27B. As a result, a current in the longitudinal direction flows through the metal pipe material 5, and the metal pipe material 5 itself generates heat due to Joule heat by electrical resistance of the metal pipe material 5 itself. After the heating, the holding by the electrodes 27A and 27B is released. The support mechanism 40B disposes the heated metal pipe material 5 at a high position (in FIG. 2, the metal pipe material 5 is disposed at a position indicated by a solid line).

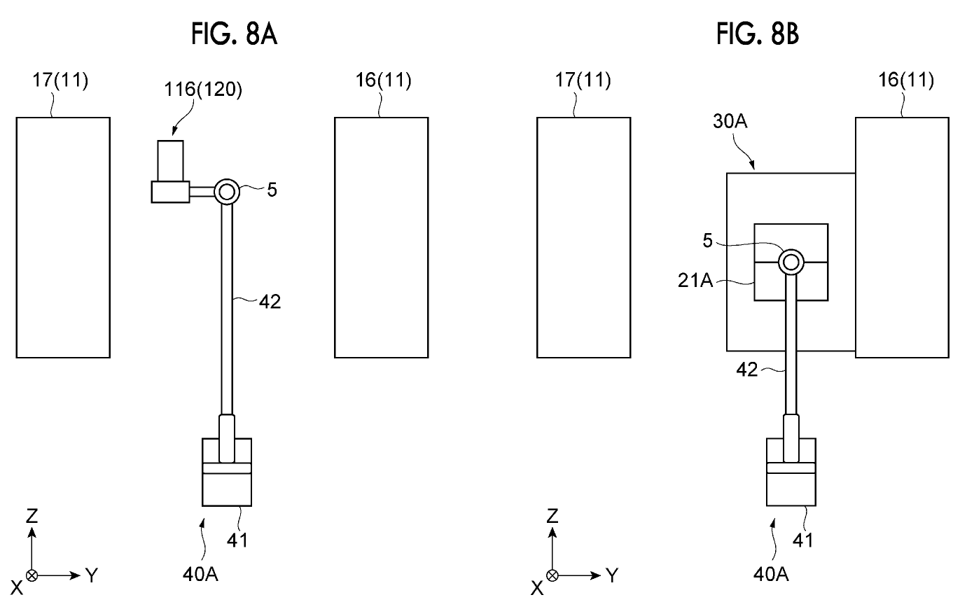

The transporter 120 holds the heated metal pipe material 5 and transports the heated metal pipe material 5 to the forming mold 11 of the forming device 10. As shown in FIG. 8A, the transporter 120 delivers the metal pipe material 5 to the support member 42 of the support mechanism 40A between the molds 16 and 17. After the delivery, the transporter 120 retreats the holder 116 from between the molds 16 and 17. Next, the units 30A and 30B move to the positive side in the Y-axis direction and move to a position of the forming mold 11 (position indicated by the units 30A and 30B shown by an imaginary line in FIG. 1). Next, as shown in FIG. 8B, the support mechanism 40A moves the metal pipe material 5 to the negative side in the Y-axis direction while lowering the metal pipe material 5, and disposes the metal pipe material 5 at positions of the holding members 21A and 21B of the units 30A and 30B. As a result, the holding members 21A and 21B hold the metal pipe material 5. The units 30A and 30B insert the nozzles 22A and 22B into the openings of the ends of the metal pipe material 5 (state shown in FIG. 3). The support mechanism 40A retreats the support member 42 from the forming mold 11.

Next, the driver 14 moves the mold 17 to the negative side in the Y-axis direction via the toggle link mechanism 70 and the movable platen 19. As shown in FIG. 6A, in the mold opening state before the movement, a distance between the flange forming surfaces 16b and 17b is D1. Next, as shown in FIG. 6B, the driver 14 stops the mold 17 at a primary blow position where a flange is shaped by supplying a fluid in a state where the flange forming surfaces 16b and 17b are spaced apart from each other as compared with a mold closing position (position shown in FIG. 7B). A distance D2 between the flange forming surfaces 16b and 17b is smaller than D1. In this case, both ends of the metal pipe material 5 come into contact with the molds 16 and 17 at corners between the flange forming surfaces 16b and 17b and the pipe forming surfaces 16a and 17a. The location is a flange-forming portion 5b that is to be the flange 50b. As shown in FIG. 7A, the fluid supplier 13 supplies the fluid to the metal pipe material 5 at the primary blow position. As a result, the metal pipe material 5 expands, and a pipe-forming portion 5a that is to be the pipe main body 50a comes into contact with the pipe forming surfaces 16a and 17a and is deformed. The flange-forming portion 5b comes into contact with the flange forming surfaces 16b and 17b and is deformed. As shown in FIG. 7B, the driver 14 further pushes the mold 17 to the positive side in the Y-axis direction and stops the mold 17 at the mold closing position. The mold closing position corresponds to a secondary blow position. As a result, the flange-forming portion 5b is crushed to be the flange 50b. The fluid supplier 13 supplies the fluid to the metal pipe material 5. As a result, the pipe-forming portion 5a is pressed against the pipe forming surfaces 16a and 17a to be the pipe main body 50a having a shape corresponding to the pipe forming surfaces 16a and 17a. Note that when the metal pipe material 5 comes into contact with the forming surfaces, the metal pipe material 5 is quenched by being rapidly cooled by the cooled forming mold 11. The primary blow position is not limited to the position as shown in FIG. 6B, and may be appropriately adjusted depending on a shape of molds, a configuration of a device, and the like.

After the forming is completed, the driver 14 moves the mold 17 to the negative side in the Y-axis direction to be in the mold opening state. The units 30A and 30B remove the nozzles 22A and 22B from the metal pipe 50. The support mechanism 40A supports the metal pipe 50 by the support member 42. The holding members 21A and 21B release the holding of the metal pipe 50. As shown in FIG. 2, the transporter 120 holds the metal pipe 50 by the holder 116 and transports the metal pipe 50 to a process on a downstream side. As described above, an operation of one cycle of the forming system 100 is completed.

Next, operations and effects of the forming system 100 according to the present embodiment will be described.

The forming device 10 includes at least a pair of molds 16 and 17 that move relative to each other in the moving direction MD along the horizontal direction. Therefore, unlike a case where the molds move in the up-down direction, the forming can be performed in a state where weights of both the molds 16 and 17 are supported by the floor surface. That is, a brake mechanism or the like for supporting the weight of the pair of molds 16 and 17 is not required. Therefore, in the forming device 10, a large force can be generated as in the case of the hydraulic pressure, but a mechanism that requires the cost for introduction is not required. As described above, the forming system 100 can be easily introduced.

The forming device may be formed by disposing the metal material in a direction intersecting the moving direction MD and being the horizontal direction with respect to the pair of molds 16 and 17. In this case, the forming device 10 can be lowered as compared with a case where the metal material is disposed from a vertical direction with respect to the pair of molds 16 and 17. Therefore, it is possible to reduce a restriction in a height direction in a building when the forming system 100 is introduced.

The forming device 10 may further include the driver 14 that moves the mold 17 and the fluid supplier 13 that supplies the fluid to the metal material, the pair of molds 16 and 17 may have the pipe forming surfaces 16a and 17a and the flange forming surfaces 16b and 17b for forming the flanged metal pipe 50, and the driver 14 may stop the mold 17 at the mold closing position that is the position of the pair of molds 16 and 17 when the metal pipe 50 is completed and at the primary blow position where the flange is formed by supplying the fluid in a state where the flange forming surfaces 16b and 17b are spaced apart from each other as compared with the mold closing position. In this case, a part of the metal material can be inserted between the flange forming surfaces 16b and 17b at the primary blow position that is a stage before the mold closing position is completely reached. As a result, it is possible to suppress cracking or the like as compared with a case where the flange is formed at once.

The forming device 10 may further include the support mechanism 40A that supports the transported metal material at a position between the pair of molds 16 and 17 and aligns a position of the metal material. In this case, the metal material can be disposed at an accurate position by the support mechanism 40A.

The forming system 100 may further include the transporter 120 that disposes the metal material with respect to the pair of molds 16 and 17 and the transporter 130 that takes out the formed product from the pair of molds 16 and 17, and the transporter 120 and the transporter 130 may be disposed to sandwich the forming device 10. In this case, the metal material before the forming and the formed product can be quickly exchanged.

The forming device 10 may further include the pair of fluid suppliers 13 that supply the fluid to the metal material, and the pair of fluid suppliers 13 may be disposed to sandwich the molds 16 and 17. In this case, the fluid can be supplied from both sides to the metal material disposed between the pair of molds 16 and 17.

The forming device 10 may further include the driver 14 that moves the molds 16 and 17, and the driver 14 may include the toggle link mechanism 70. In this case, the molds can be moved with a large force even with a small driving force with respect to the molds 16 and 17 disposed such that the moving direction MD is along the horizontal direction.

For example, in a case of an expansion forming device that moves the molds in the up-down direction by using a hydraulic press, large-scale foundation work is required, such as the need for an underground pit. In addition, there is an issue in that a hydraulic unit and pipes are required, and hydraulic adjustment or the like is required during a trial operation, resulting in a long construction period until startup. That is, there is an issue in that in the hydraulic press, an initial cost at the time of introduction is high. In contrast, since the forming device 10 according to the present embodiment is a mechanism that moves the mold in the moving direction along the horizontal direction, a hydraulic machine and pipes are not required. Since the forming device 10 can be installed at a floor level, it is not necessary to generate an underground pit, and the construction cost can be suppressed. Here, the mechanism that moves the mold by using the toggle link mechanism is a mechanism that has been used in an injection molding device or the like. Therefore, since the mechanism can be replaced with an existing injection molding device, the cost can be significantly reduced. In addition, since the driver driven by electricity instead of hydraulic pressure is included, any slide motion can be performed unlike the hydraulic pressure.

The driver 14 may include a motor 67, and the motor 67 may be provided in the moving direction MD. In this case, since a power transmission mechanism such as a V-belt or a timing belt is not required separately, the driver 14 that is less likely to break can be provided. In addition, the size of the forming system 100 in the height direction can be limited.

The present disclosure is not limited to the above embodiment.

The forming device is not limited to a device that performs the heat expansion shaping as described above. For example, the present disclosure may be adopted for a forming device for sheet metal forming or hydroforming.

As the metal material in a non-molten state, in addition to the heated metal pipe material, a metal pipe material at room temperature, a heated metal sheet, a metal sheet at room temperature, or the like may be adopted.

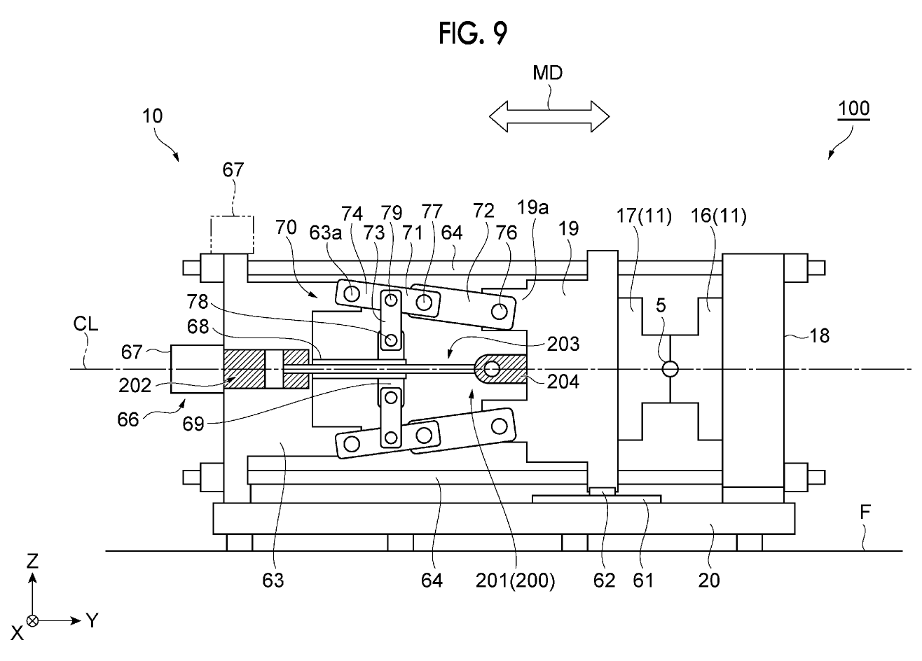

FIG. 9 is a schematic side view showing a configuration of a forming system 100 according to a modification example. In the toggle link mechanism 70, a gap may occur in a gear for mold thickness adjustment, and a gap may occur in a sliding portion of a link of the toggle link mechanism 70. In these gaps, rattling is likely to occur. In contrast, as shown in FIG. 9, the toggle link mechanism 70 may be provided with a rattling suppression mechanism 200 that suppresses rattling occurring in the above-described gaps. The rattling suppression mechanism 200 suppresses the rattling, so that position controllability of the molds 16 and 17 can be improved.

The rattling suppression mechanism 200 may include a load applying mechanism 201 that applies a load to the toggle link mechanism 70 side. The load applying mechanism 201 is configured by a damper. The load applying mechanism 201 includes a piston 202 and a rod 203. The piston 202 is provided in the base member 63. The rod 203 extends from the piston 202 toward the movable platen 19 on the positive side of the Y-axis direction. The rod 203 is connected to the movable platen 19 via a coupling portion 204 at an end on the positive side of the Y-axis direction. The load applying mechanism 201 can apply a load for pulling the movable platen 19 toward the toggle link mechanism 70 side. In this way, the load applying mechanism 201 applies the load to the toggle link mechanism 70 side, so that the occurrence of the gaps that cause the rattling can be suppressed. In this manner, the rattling is suppressed, so that the position controllability of the molds 16 and 17 can be improved.

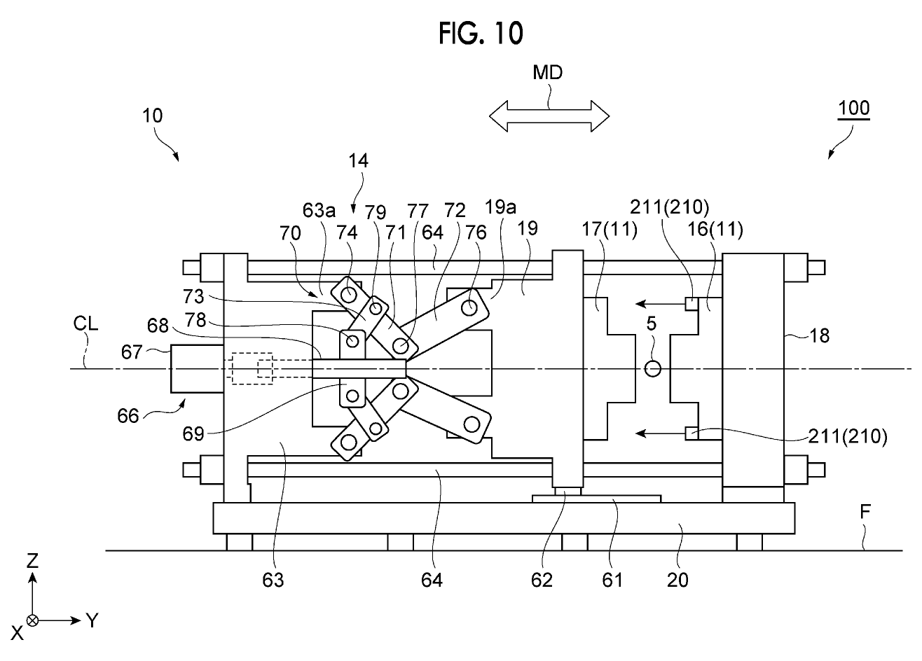

FIG. 10 is a schematic side view showing a configuration of the forming system 100 according to the modification example. As shown in FIG. 10, the toggle link mechanism 70 may include a position detection mechanism 210 that detects a position of the movable mold 17. The position detection mechanism 210 includes a position detection sensor 211 that detects the position of the mold 17 that is in operation. The position detection sensor 211 is not particularly limited, and a laser sensor or the like may be adopted. In FIG. 10, the position detection sensor 211 is provided in the mold 16 on a stationary side, but the attachment position is not particularly limited as long as the position can be detected. In this case, even in a case where rattling occurs in a gap generated in a gear for mold thickness adjustment, a gap generated between a mold thickness position adjustment nut and a toggle support, and in a gap in a sliding portion of a link of the toggle link mechanism, the position detection mechanism 210 detects the position of the movable mold 17, so that the position of the movable mold 17 can be feedback-controlled, and thus the position controllability of the mold 17 can be improved.

In the above-described embodiment, the motor 67 is provided in the moving direction MD. Instead of this, the motor 67 may be provided in a direction intersecting the moving direction MD. In this case, the size of the forming system 100 in the moving direction MD can be suppressed. In addition, in a case where the motor 67 is disposed on an upper side of the forming system 100 (for example, refer to the motor 67 indicated by an imaginary line in FIG. 9), maintenance can be performed from the upper side, so that maintainability can be improved.

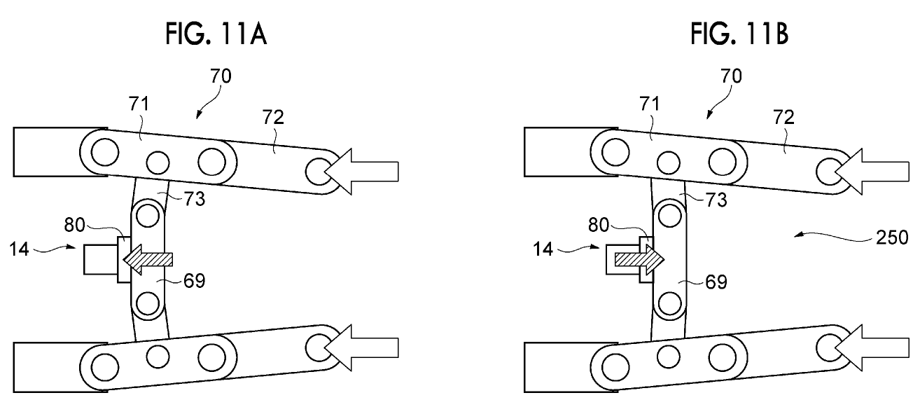

FIGS. 11A and 11B are schematic views for explaining a lock-up mechanism 250. The toggle link mechanism 70 may include the lock-up mechanism 250 that retains a mold clamping force. In this case, since the lock-up mechanism 250 can retain the mold clamping force, mold opening can be suppressed even in a case where a reaction force is received from the metal material disposed in the mold. The lock-up mechanism 250 may be operated at the time of stopping. In this case, the lock-up mechanism 250 can suppress the mold opening at the time of stopping. For example, even in a case where the power cutoff of the driver 14 occurs due to the stopping in a state where an internal pressure remains in the metal material, the lock-up mechanism 250 can mechanically withstand the reaction force of the metal material, so that rupture of the metal material due to the mold 17 being pushed back by the reaction force can be suppressed. Examples of the stopping include an emergency stopping. The emergency stopping includes stopping the device in a case where a safety device determines that there is a danger (the safety device is released, an emergency button is pressed, or the like). In addition to the emergency stopping, the lock-up mechanism 250 may be operated at the time of a process stopping such as the power cutoff. For example, the same process may be performed even in a case where an operation is stopped due to overload of the motor (temperature monitoring), or in a case of abnormality processing or monitoring process such as abnormality of an inverter or cycle monitoring abnormality. In addition, the mold clamping force may be retained by the lock-up mechanism 250 during a setup operation while the mold is installed. In this case, the mold clamping force can be applied for a long time with a low load on the motor.

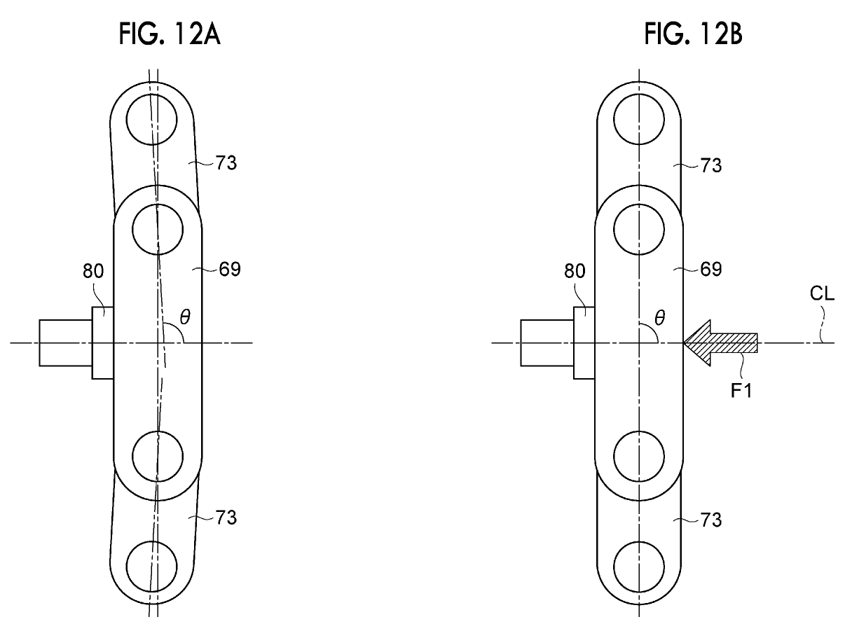

As shown in FIG. 12B, in a case where an angle of the link member 73 connected to the moving member 69 forms 90° with respect to the center line CL, a toggle ratio becomes infinite, so that a mold clamping state of the forming mold 11 can be maintained even in a case where there is no motor thrust. This state is referred to as a “lock-up state”.

For example, as shown in FIG. 11A, in a case where a crosshead 80 (a member that rotates with respect to the ball screw 68 to move the moving member 69) is disposed at a position retreated from the lock-up state at the time of the emergency stopping, there is a possibility that the crosshead 80 is retreated by a reaction force from the mold 17. On the other hand, in the lock-up mechanism 250 shown in FIG. 11B, the crosshead 80 is disposed at a position advanced from the lock-up state at the time of the emergency stopping. FIG. 12A shows an enlarged view of a state of the link member 73 in this state. As shown in FIG. 12A, an angle θ formed by the link member 73 with respect to the center line CL is in a state of being larger than 90°. In a case where the reaction force F1 acts from the mold 17 as shown in FIG. 12B from this state, the crosshead 80 and the moving member 69 retreat. In this case, the angle θ of the link member 73 with respect to the center line CL is 90°, so that the lock-up state is achieved. As a result, the movement of the crosshead 80 and the moving member 69 is mechanically stopped.

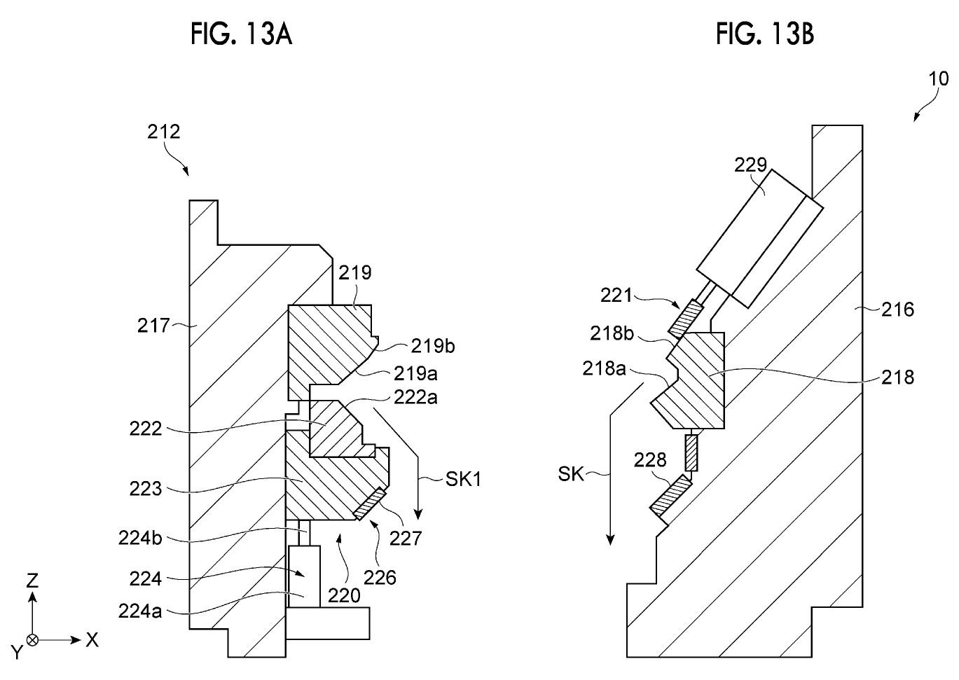

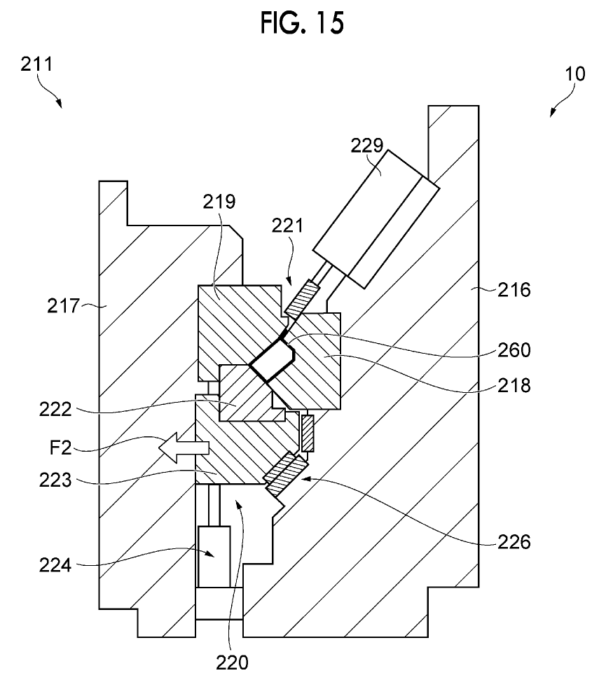

The forming device 10 may adopt a forming mold 212 as shown in FIGS. 13A and 13B. The forming mold 212 includes molds 216 and 217 that move relative to each other in the horizontal direction, and double-action molds 220 and 221. The mold 216 is a stationary mold of which the position is fixed. The mold 217 is a movable mold that moves in the horizontal direction with respect to the mold 216. The double-action mold 220 is disposed on a lower side in a direction (up-down direction) intersecting the horizontal direction with respect to the metal material. The double-action mold 221 is disposed on an upper side in a direction (up-down direction) intersecting the horizontal direction with respect to the metal material. Such a forming mold 212 can form a flanged metal pipe 260 (refer to FIG. 15).

The mold 216 includes a forming portion 218 having a forming surface. The forming portion 218 has a forming surface 218a for forming a pipe main body of the flanged metal pipe 260, and a flange forming surface 218b for forming the flange. The mold 217 includes a forming portion 219 having a forming surface. The forming portion 219 has a forming surface 219a for forming the pipe main body of the flanged metal pipe 260, and a flange forming surface 219b for forming the flange.

The double-action mold 220 is provided with respect to the mold 217 that is a movable mold. Therefore, the double-action mold 220 moves in the horizontal direction together with the mold 217. The double-action mold 220 includes a forming portion 222 having a forming surface, and a support 223 that supports the forming portion 222. The forming portion 222 has a forming surface 222a for forming a pipe main body of the flanged metal pipe 260. The support 223 supports the forming portion 222 on an upper end side. The double-action mold 220 includes a guide mechanism 224 that allows the forming portion 222 and the support 223 to move in the up-down direction and that restricts movement in the horizontal direction. The guide mechanism 224 is provided on a lower side of the support 223 and is connected to the support 223. The guide mechanism 224 includes a cylinder 224a fixed to the mold 217, and a rod 224b that moves in the up-down direction together with the support 223.

In addition, the double-action mold 220 includes a moving mechanism 226 that moves from the lower side to the upper side in conjunction with mold closing during the forming. The moving mechanism 226 is configured by a tapered surface 227 formed on the positive side in the Y-axis direction on the lower end side of the support 223. The tapered surface 227 is inclined upward as going toward the positive side in the Y-axis direction. The tapered surface 227 is guided by coming into contact with a guide tapered surface 228 formed on the mold 216, which is a stationary mold. The guide tapered surface 228 is formed to extend from an end surface of the mold 216 on the negative side in the Y-axis direction and to the negative side in the Y-axis direction. The guide tapered surface 228 is inclined downward as going toward the negative side in the Y-axis direction.

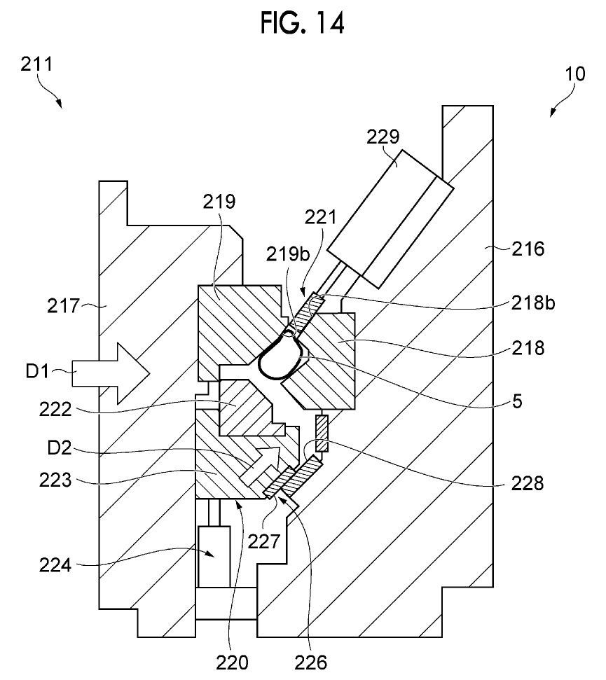

As shown in FIG. 14, when the double-action mold 220 moves in the mold closing direction D1 (the negative side in the Y-axis direction) together with the mold 217, which is a movable mold, the tapered surface 227 comes into contact with the guide tapered surface 228 on the stationary mold side. In a case where the double-action mold 220 further moves in the mold closing direction D1 from that state, the tapered surface 227 is guided by the guide tapered surface 228, and thus the double-action mold 220 moves in an oblique upward direction D2. In this way, the double-action mold 220 moves from a lower side to an upper side in conjunction with mold closing by the moving mechanism 226 during the forming. In this manner, the double-action mold 220 closes the mold in the upward direction with respect to the mold 217, which is a movable mold. During mold opening, the double-action mold 220 moves to the negative side in the Y-axis direction together with the mold 217. In conjunction with this, the tapered surface 227 slides down in an oblique downward direction (a direction opposite to the direction D2) along the guide tapered surface 228. In this case, the double-action mold 220 moves downward due to its own weight. In this way, the double-action mold 220 returns to the original position due to its own weight during the mold opening. The guide mechanism 224 may include an elastic member (spring) that pulls the double-action mold 220 downward during mold opening, but may not include such an elastic member.

The double-action mold 221 is a mold for controlling the size of a flange during the forming. The double-action mold 221 is connected to a drive mechanism 229 provided in the mold 216, which is a stationary mold. The drive mechanism 229 is a mechanism that reciprocates the double-action mold 221 in an oblique up-down direction. The drive mechanism 229 moves the double-action mold 221 obliquely downward toward the negative side in the Y-axis direction during the primary blow shown in FIG. 14. In this manner, the double-action mold 221 is disposed in a space between the flange forming surface 218b and the flange forming surface 219b. After the primary blow, the drive mechanism 229 moves the double-action mold 221 obliquely upward toward the positive side in the Y-axis direction to retreat the double-action mold 221 (refer to FIG. 15).

A procedure for forming the flanged metal pipe 260 by the forming mold 212 will be described with reference to FIGS. 14 and 15. First, the metal pipe material 5 is disposed between the molds 216 and 217, and the mold 217, which is a movable mold, is moved to the primary blow position (position shown in FIG. 14). In this case, as shown in FIG. 14, the double-action mold 221 is disposed in the space between the flange forming surface 218b and the flange forming surface 219b. In this state, the forming portions 218, 219, and 222 are not in a complete mold closing state. The metal pipe material 5 is deformed into a shape corresponding to each forming surface of the forming portions 218, 219, and 222. In this state, the primary blow is performed on the metal pipe material 5. In this manner, a part of the metal pipe material 5 (flange-forming portion) enters the space between the flange forming surface 218b and the flange forming surface 219b. A length of the flange-forming portion is restricted by the double-action mold 221.

Next, the drive mechanism 229 retreats the double-action mold 221 from the space between the flange forming surface 218b and the flange forming surface 219b. The double-action mold 220 is further moved in the mold closing direction D1 together with the mold 217 to be moved to the secondary blow position (position shown in FIG. 15). In this state, the forming portions 218, 219, and 222 are in the complete mold closing state. The metal pipe material 5 is deformed into a shape corresponding to each forming surface of the forming portions 218, 219, and 222. Secondary blow is performed in this state to complete the flanged metal pipe 260.

As described above, the forming device 10 may further include the double-action molds 220 and 221, and the double-action molds 220 and 221 may be disposed on any one side in a direction intersecting the horizontal direction with respect to the metal material. In this case, the metal material can be formed into a complicated shape by the double-action molds 220 and 221. Here, in a case where the pair of molds 216 and 217 moves in the up-down direction, there is an issue in that suction work or the like is required because an oxide scale is likely to be deposited on the lower mold. On the other hand, in the pair of molds 216 and 217 that relatively move in the horizontal direction, the oxide scale is likely to fall downward, and thus the oxide scale can be easily removed by blowing off the oxide scale by the blow or the like. For example, an oxide scale SK1 adhering to the mold 216 falls downward, and an oxide scale SK2 adhering to the mold 217 falls downward (refer to FIGS. 13A and 13B). In a case where the double-action molds 220 and 221 are adopted, an adverse effect due to a deposition of the oxide scale is more remarkable. Therefore, in the forming device 10, the adverse effect can be suppressed by adopting a configuration in which the oxide scale is easily removed.

The double-action mold 220 may include the moving mechanism 226 that moves from the lower side to the upper side in conjunction with the mold closing during the forming, and the double-action mold 220 may return to the original position by its own weight during the mold opening. In this case, the mechanism for returning the double-action mold 220 to the original position can be reduced in size or omitted. For example, in a case where the double-action mold 220 is provided on the upper side with respect to the metal material, a mechanism for lifting the weight of the double-action mold 220 from the lower side to the upper side is required when the double-action mold 220 is retreated after the forming. Since the moving mechanism 226 can be retreated by using the weight of the double-action mold 220, a mechanism for lifting the double-action mold 220 can be unnecessary.

In a case where the double-action mold 220 receives a force directed downward due to an internal pressure of the metal material when the operation is stopped, the force may be converted into a reaction force F2 in a direction opposite to the mold clamping force by the moving mechanism 226. However, since the forming device 10 includes the lock-up mechanism 250 (refer to FIGS. 11A and 11B) described above, the mold clamping force can be maintained even against such a reaction force F2.

It should be understood that the invention is not limited to the above-described embodiment, but may be modified into various forms on the basis of the spirit of the disclosure. Additionally, the modifications are included in the scope of the disclosure.

What is claimed is:

1. A forming system comprising:
a forming device configured to form a metal pipe material in a non-molten state,
wherein the forming device
includes at least a pair of molds that move relative to each other in a moving direction along a horizontal direction, and
the forming device is configured to
perform the forming by disposing the metal pipe material from a direction intersecting the moving direction with respect to the pair of molds, and
supply a gas to an inside of the metal pipe material to form an expanded metal pipe material.

2. The forming system according to claim 1, further comprising:
a material disposition unit configured to dispose the metal pipe material immediately before the forming by the forming device.

3. The forming system according to claim 2,
wherein the material disposition unit is provided with an energization heater that energizes and heats the metal pipe material by causing a current to flow through the metal pipe material.

4. The forming system according to claim 1,
wherein the forming device performs the forming by disposing the metal material from the direction intersecting the moving direction with respect to the pair of molds, the direction being a horizontal direction.

5. The forming system according to claim 1,
wherein the forming device further includes
a driver configured to move the molds, and
a fluid supplier configured to supply a fluid to the metal material,
the pair of molds include pipe forming surfaces for forming a flanged metal pipe and flange forming surfaces, and
the driver stops the molds at a mold closing position that is a position of the pair of molds when the metal pipe is completed, and at a primary blow position where a flange is formed by supplying the fluid in a state where the flange forming surfaces are spaced apart from each other as compared with the mold closing position.

6. The forming system according to claim 1,
wherein the forming device further includes a support mechanism configured to support the metal material that has been transported at a position between the pair of molds and align a position of the metal material.

7. The forming system according to claim 6,
wherein the support mechanism includes a high-speed lift and a support member, the high-speed lift is configured to advance and retreat the support member in an up-down direction, the support member is supported by the high-speed lift, extends upward, and is configured to support the metal pipe material at an upper end, and
a plurality of the support mechanisms are provided along a longitudinal direction of the metal pipe material.

8. The forming system according to claim 1, further comprising:
a first transporter configured to dispose the metal material with respect to the pair of molds; and
a second transporter configured to take out a formed product from the pair of molds, wherein the first transporter and the second transporter are disposed to sandwich the forming device.

9. The forming system according to claim 1,
wherein the forming device further includes a pair of fluid suppliers configured to supply a fluid to the metal material, and
the pair of fluid suppliers are disposed to sandwich the molds.

10. The forming system according to claim 9,
wherein the pair of fluid suppliers each includes a nozzle that supplies the fluid from an opening of an end of the metal pipe material to an inside of the metal pipe material, and a drive mechanism that advances and retreats the nozzle with respect to the opening.

11. The forming system according to claim 1,
wherein the forming device further includes a driver configured to move the molds, and
the driver includes a toggle link mechanism.

12. The forming system according to claim 11,
wherein the toggle link mechanism is provided with a rattling suppression mechanism configured to suppress rattling occurring in a gap that is provided in a gear for mold thickness adjustment and in a gap in a sliding portion of a link of the toggle link mechanism.

13. The forming system according to claim 12,
wherein the rattling suppression mechanism includes a load applying mechanism configured to apply a load to a toggle link mechanism side.

14. The forming system according to claim 11,
wherein the toggle link mechanism includes a position detection mechanism configured to detect a position of a movable mold.

15. The forming system according to claim 11,
wherein the driver includes a motor, and
the motor is provided in the moving direction.

16. The forming system according to claim 11,
wherein the driver includes a motor, and
the motor is provided in a direction intersecting the moving direction.

17. The forming system according to claim 11,
wherein the toggle link mechanism includes a lock-up mechanism configured to retain a mold clamping force.

18. The forming system according to claim 17,
wherein the lock-up mechanism is operated at a time of stopping.

19. The forming system according to claim 1,
wherein the forming device further includes a double-action mold, and
the double-action mold is disposed on any one side of the metal material in a direction intersecting the horizontal direction.

20. The forming system according to claim 19,
wherein the double-action mold includes a moving mechanism configured to move from a lower side to an upper side in conjunction with mold closing at a time of forming, and
the double-action mold returns to an original position by its own weight at a time of mold opening.
